(19) United States
(12) Patent Application Publication
(10) Pub. No.: US 2007/0223759 A1
(43) Pub. Date: Sep. 27, 2007

(54) Hearing apparatus with an open-porous cerumen protection facility

(75) Inventor: Gerhard Ach-Kowalewski, Effeltrich (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GmbH

(21) Appl. No.: 11/728,917

(22) Filed: Mar. 27, 2007

(30) Foreign Application Priority Data
Mar. 27, 2006 (DE) 10 2006 014 023.0

(51) Int. Cl. H04R 25/00

(52) U.S. Cl. 381/328; 381/322

(57) ABSTRACT

The sound outlet opening of a hearing device or another hearing apparatus is to be effectively protected against cerumen. To this end, provision is made for a cerumen protection facility to be arranged at the sound outlet opening, said cerumen protection facility consisting at least partially of an open-porous material, e.g. sponge for absorbing the cerumen. A ring-shaped sponge is preferably mounted on a carrier, which is fastened to a hearing device or to an otoplastic.

### CROSS REFERENCE TO RELATED APPLICATIONS

This application claims priority of German application No. 10 2006 014 023.0 filed Mar. 27, 2006, which is incorporated by reference herein in its entirety.

### FIELD OF THE INVENTION

The present invention relates to a hearing apparatus, which extends at least partially into the auditory canal when being worn, having a sounding facility comprising a sound outlet opening and having a cerumen protection facility, with which the sound outlet opening can be protected against penetrating cerumen, with the cerumen protection facility at least partially consisting of an open-porous material for absorbing cerumen.

### BACKGROUND OF THE INVENTION

With hearing apparatuses of any type, it is necessary to protect these or the part of the respective hearing apparatus, which protrudes into the auditory canal, against cerumen, sweat and other contamination. This is the only method of guaranteeing that the sound is routed to the ear drum in the best possible manner.

Numerous cerumen protection systems are known on the market. Special sieves, filters and valves are used for instance. Specially formed cerumen guard hearing devices are also to be protected against contamination. It is however common to these cerumen protection facilities that they clog relatively quickly, but that they also minimize the maximum possible sound level in an uncontaminated condition.

An apparatus for preventing the penetration of cerumen and other foreign matter in the sound conduction openings and air conduction openings of hearing devices is known from the publication DE 39 33 584 A1. This apparatus consists of a plug made of a mechanically stable, highly-porous material, preferably a sintered material based on metal.

The publication U.S. Pat. No. 5,401,920 furthermore discloses a cerumen filter for hearing devices. The filter material can be an open-porous foam for instance.

A further apparatus for sealing openings on hearing devices or ear molds for hearing devices is described in the publication EP 0 310 866 A1. The cerumen protection facility is integrated in a projection, which points toward the ear drum.

### SUMMARY OF THE INVENTION

The object of the present invention thus consists in proposing a hearing apparatus, the cerumen protection facility of which adequately protects the sound outlet opening against contamination on the one hand and on the other hand causes as little attenuation of the useful sound as possible. Furthermore, a corresponding method for protecting a sounding facility is to be specified.

In accordance with the invention, this object is achieved by means of a hearing apparatus, which extends at least partially into the auditory canal when being worn, having a sounding facility comprising a sound outlet opening, and having a cerumen protection facility with which the sound outlet openings can be protected against penetrating cerumen, with the cerumen protection facility consisting at least partially of an open-porous material for absorbing cerumen and with the cerumen protection facility being designed to be ring-shaped and being attached to the sound outlet opening, so that the sound passes through the ring opening (3) of the cerumen protection facility.

The cerumen is advantageously absorbed by means of the open-porous cerumen protection facility and can thus hardly reach the sound channel and/or the receiver. The sound can thus constantly emerge unattenuated, provided the absorbency of the cerumen protection facility is guaranteed.

In accordance with the invention, the cerumen protection facility is designed to be ring-shaped and is attached to the sound outlet opening so that the sound passes through the ring opening of the cerumen protection facility. According to a development, the ring opening can also be closed by a thin layer of the open-porous material, so that practically no more dirt can penetrate into the protected sound channel.

The open-porous material of the cerumen protection facility can be a sponge for instance. This material is simple and cost-effective to manufacture.

The cerumen protection facility advantageously comprises a carrier, on which the open-porous material is mounted, and which is used for fastening to the sounding facility. This carrier can be designed in a very individual manner so that all types of fastening possibilities can be used. The material of the carrier can also be selected almost arbitrarily. Plastic, rubber or metal are particularly suited to this.

The carrier of the cerumen protection facility can also be fastened to the sounding facility in a detachable manner. This enables it to be easily exchanged by the user when in a fully-absorbed condition.

As already indicated, the sounding facility can be a receiver or a receiver tube. This means that the cerumen protection facility can then also be used, when the sound is generated in the auditory canal, and also when the sound is conducted from the outside via a receiver tube into the auditory canal.

It was likewise already indicated that the hearing apparatus can be designed as a hearing device. In particular, an in-the-ear hearing device can be equipped with an open-porous cerumen protection facility on the receiver output. A receiver tube which originates from a behind-the-ear hearing device can likewise be provided with the open-porous cerumen protection facility.

### BRIEF DESCRIPTION OF THE DRAWINGS

The present invention is now explained in more detail below with reference to the appended drawings, in which;

FIG. 1 shows a cross-sectional view through a cerumen protection facility according to a first embodiment;

FIG. 2 shows a top view onto the cerumen protection facility in FIG. 1.

### DETAILED DESCRIPTION OF THE INVENTION

The exemplary embodiment illustrated in more detail below represents a preferred embodiment of the present invention.

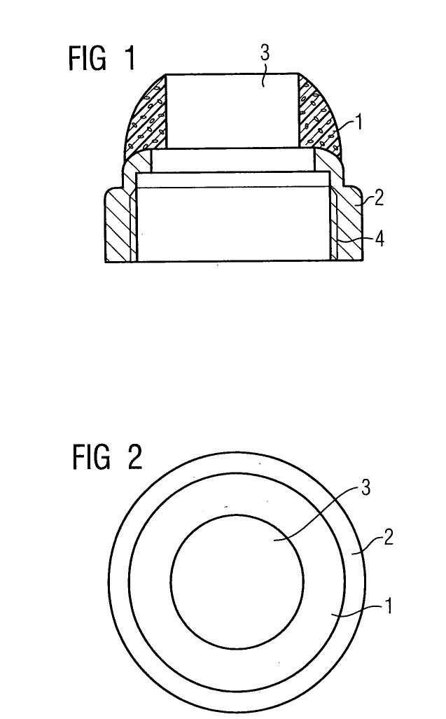

The cerumen protection facility according to the present invention reproduced in FIG. 1 essentially consists of a ring-shaped sponge 1. The internal diameter of this ring determines the size of the sound outlet opening 3 of the cerumen protection facility. The sponge 1 is glued here to a likewise ring-shaped carrier 2. This exhibits an inner thread 4 on the side facing away from the sponge 1. This inner thread 4 serves to screw the carrier onto a corresponding external thread of a receiver support, a hearing device support or a receiver tube connection etc.

FIG. 2 shows a top view of the cerumen protection facility in FIG. 1. It is clear here that the sound outlet opening 3 is surrounded by the cerumen-absorbent foam 1 in a ring-shaped manner.

The cerumen protection facility basically comprises an open-porous material. The capillary forces enable the liquid cerumen to be absorbed before hardens in the air in the manner of wax. Foam material has proven to be a suitable absorbent material for instance.

The carrier 2 is manufactured for instance from a plastic, rubber or a metal and/or metal alloy. It should essentially be easily exchangeable together with the cerumen sponge 1. Furthermore, the carrier 2 can almost be configured arbitrarily so that in-the-ear hearing devices, behind-the-ear hearing device otoplastics or pocket hearing device receivers or such like can be effectively protected using the sponge-like cerumen protection facility. The inventive solution advantageously allows no cerumen to reach the sound channel and/or receiver, since it is absorbed beforehand by the cerumen sponge. In this way, the sound can always emerge unattenuated from the sound outlet opening.

According to alternative forms of embodiment, the carrier can be attached or screwed onto the receiver. Furthermore, the carrier can also be designed as a rubber ring for clamping onto a support.

1-7. (canceled)

8. A hearing apparatus extending at least partially into an auditory canal of a user, comprising:
a sounding unit comprising a sound outlet opening; and
a ring-shaped cerumen protection unit comprising an open-porous material that protects the sound outlet opening against a cerumen of the user, the cerumen protection unit being attached to the sound outlet opening so that a sound penetrates through a ring opening of the cerumen protection unit.

9. The hearing apparatus as claimed in claim 8, wherein the open-porous material absorbs the cerumen.

10. The hearing apparatus as claimed in claim 8, wherein the open-porous material is a sponge.

11. The hearing apparatus as claimed in claim 8, wherein the cerumen protection unit comprises a carrier on which the open-porous material is mounted.

12. The hearing apparatus as claimed in claim 11, wherein the carrier comprises a material selected from the group consisting of: plastic, rubber, and metal.

13. The hearing apparatus as claimed in claim 11, wherein the carrier is fastened to the sounding unit.

14. The hearing apparatus as claimed in claim 13, wherein the carrier is detachably fastened to the sounding unit.

15. The hearing apparatus as claimed in claim 8, wherein the sounding unit is a receiver or a receiver tube.

16. The hearing apparatus as claimed in claim 8, wherein the hearing apparatus is a hearing device.

17. A method for protecting a sounding unit of a hearing apparatus against a cerumen of a user of the hearing apparatus, comprising:
arranging a ring-shaped cerumen protection unit comprising an open-porous material;
attaching the ring-shaped cerumen protection unit to a sound outlet opening of the sounding unit so that a sound penetrates through a ring opening of the cerumen protection unit; and
absorbing the cerumen of the user by the open-porous material to protect the sounding unit.

18. The method as claimed in claim 17, wherein the open-porous material is a sponge.

19. The method as claimed in claim 17, wherein the cerumen protection unit comprises a carrier on which the open-porous material is mounted.

20. The method as claimed in claim 19, wherein the carrier comprises a material selected from the group consisting of: plastic, rubber, and metal.

21. The method as claimed in claim 19, wherein the carrier is fastened to the sounding unit.

22. The method as claimed in claim 21, wherein the carrier is detachably fastened to the sounding unit.

23. The method as claimed in claim 17, wherein the sounding unit is a receiver or a receiver tube.

24. The method as claimed in claim 17, wherein the hearing apparatus is a hearing device.
